(19) United States
(12) Patent Application Publication
(10) Pub. No.: US 2025/0353798 A1
(43) Pub. Date: Nov. 20, 2025

(54) Manure Sanitizer

(71) Applicants: Philip Wessels, North Mankato, MN (US); Marco Doda, Cesole (IT)

(72) Inventors: Philip Wessels, North Mankato, MN (US); Marco Doda, Cesole (IT)

(21) Appl. No.: 19/206,935

(22) Filed: May 13, 2025

Related U.S. Application Data
(60) Provisional application No. 63/647,480, filed on May 14, 2024.

(51) Int. Cl. C05F 17/60; C05F 17/929; C05F 17/971

(52) U.S. Cl. CPC C05F 17/60; C05F 17/929; C05F 17/971

(57) ABSTRACT

A device which facilitates the sanitation of manure and similar materials in an improved way. The device moves the subject material through a series of augers. As the material moves though the augers in series, the material is subject to high heat from continuous heating elements along each auger. The augers are arranged in one or more layers with each individual auger of a layer moving material through itself and transferring to the next auger in the series until the material has moved through the device. The machine provides for improved sanitization efficiency and efficacy due to the manner in which heat and friction are applied. Byproducts may be harnessed or released as desired.

### FIELD OF THE INVENTION

The present invention relates generally to the field of horticultural waste sanitation. Specifically, the present invention is a machine which heats solid animal waste in order to dry it and kill microorganism inhabiting the material.

### BACKGROUND OF THE INVENTION

Waste management for modern horticulture is a massive undertaking when considered at scale. Solid waste presents several difficulties for waste managers to properly dispose or to prepare it for storage and reuse. One difficulty is that it contains a significant amount of bacteria and other microorganisms working to break it down. E. Coli and other potential risks to humans, livestock, and food can be found in this biome. Another challenge is that it may have varying amounts of moisture and levels of consistency. Transporting wet manure is heavier and less energy efficient, in addition to the contamination and disease risks.

A common existing approach to sanitizing manure at an industrial level is to apply heat so that bacteria are destroyed to government standards and the water weight of the material is reduced by the drying action. This heat-drying is often performed by composting and windrows or slowly pushing the material along an open channel heated by ultraviolet light. These sanitizing machines require massive amounts of space and electrical power, particularly along the length of the channel or conveyor. The present invention reduces the space requirements and accelerates the process by using a series of augers to churn the materials and move it through the machine in enclosed tubes. The augers are placed to operate in alternating directions so that less space is used. Heat is applied to these augers in a more efficient manner by the nature of the compact configuration and enclosed tubes. By enclosing the augers inside the tubes, less power is required for heating, and higher temperatures can be attained, which in turn reduces the time needed to kill the bacteria and thus increases the throughput. The enclosed tubes also serve the additional purpose of preventing the product from smoldering or catching fire due to the lack of oxygen inside the tube. The tubes can be vented so the ammonia produced from the heating process can be siphoned off for further treatment and odor control. The resulting sterile material may be used, for example, as bedding in dairy barns or high-quality compost or fertilizer. As an alternative, an operator may decline to siphon off ammonia by-products during the heating stages. The resulting anaerobic or low-oxygen environment allows the high ammonia content to aid in destroying bacteria.

### BRIEF DESCRIPTION OF THE DRAWINGS

FIG. 1 is a top-front offset view for an embodiment of the present invention.

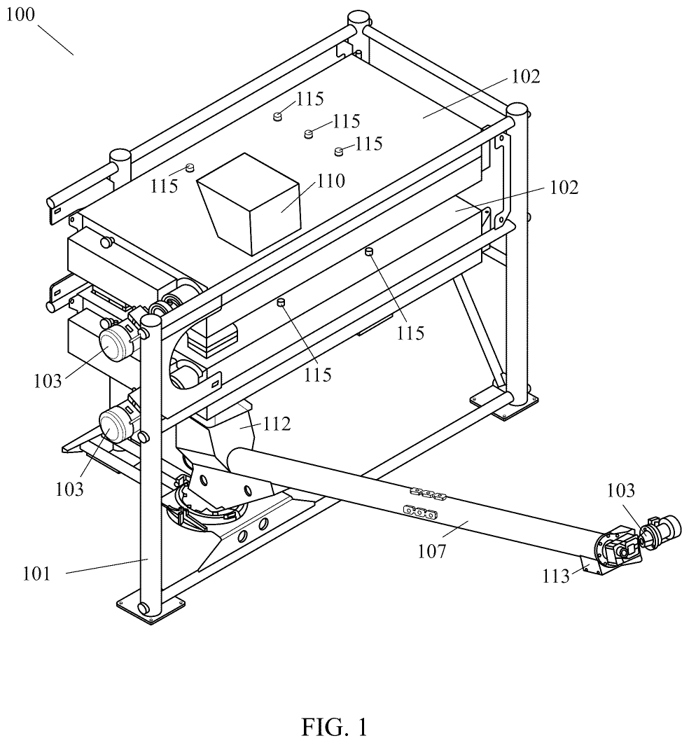

FIG. 2 is a cut-away diagram for an embodiment of the present invention, demonstrating the flow of material through the machine.

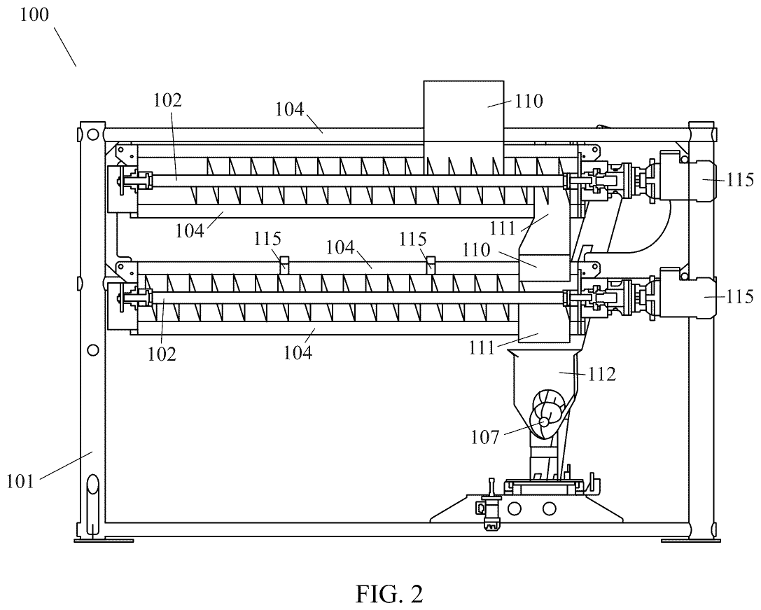

FIG. 3 is a front-left offset view for an embodiment of the present invention.

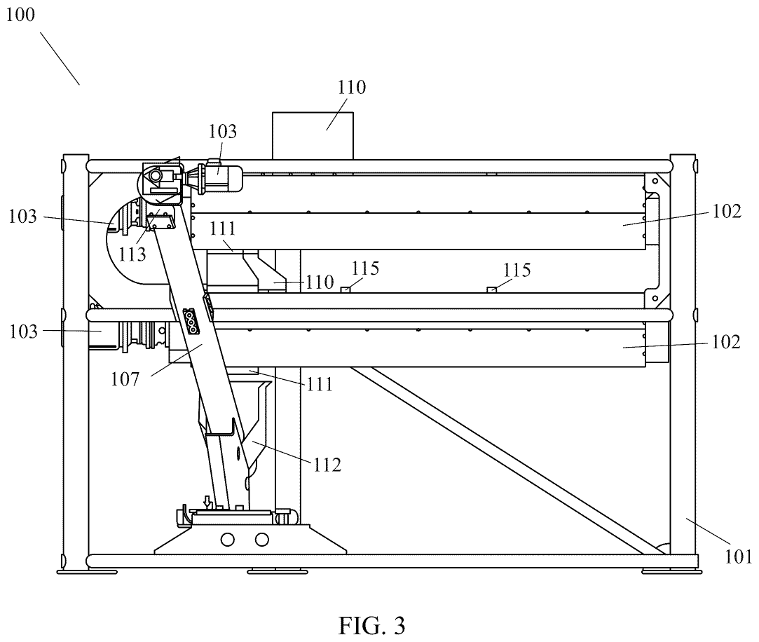

FIG. 4 is close in view of the heating elements and insulation, which envelopes the augers, including the vent ports for the ammonia gas, for an embodiment of the present invention.

FIG. 5 is a left-side view for an embodiment of the present invention.

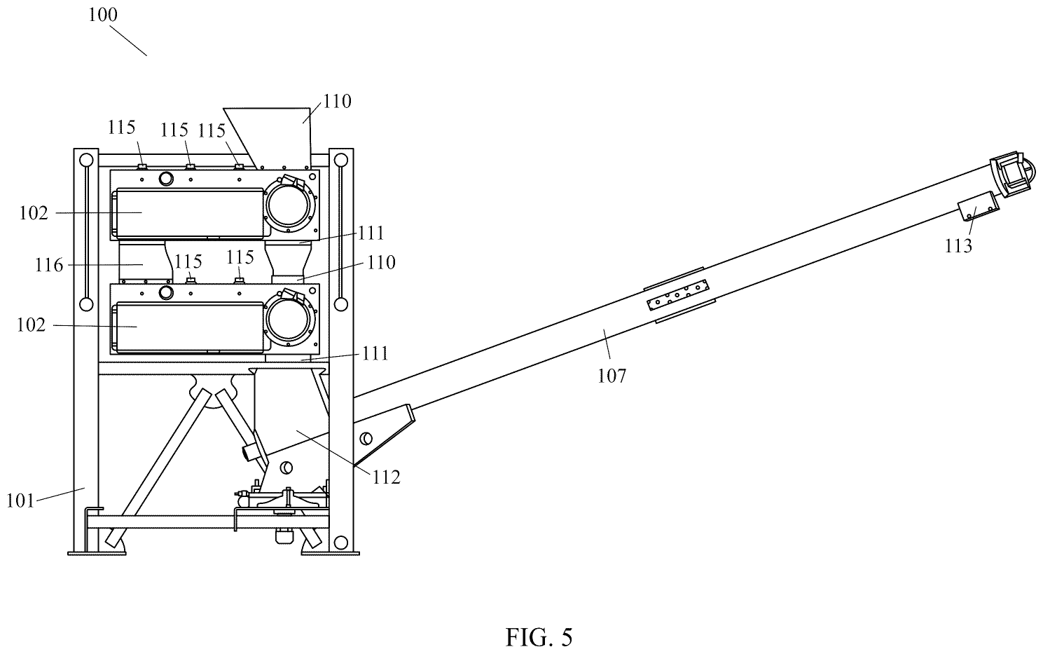

FIG. 6 is a cut-away diagram highlighting positions of the augers for an embodiment of the present invention.

FIG. 7 is a cut-away diagram for an embodiment of the present invention, demonstrating the entry and exit points for material through the machine.

FIG. 8 is an overhead view for an embodiment of the present invention, with some transparency to depict the internal structure.

### DETAIL DESCRIPTIONS OF THE INVENTION

All illustrations of the drawings are for the purpose of describing selected versions of the present invention and are not intended to limit the scope of the present invention.

The present invention is an improvement on existing technology for sanitizing manure. Though it is directed towards the needs of dairy farms, in particular, use in other industries can readily be envisioned by a person of ordinary skill in the art. After initial processing of the material through a dewatering press, for example, a screw press, the waste is deposited into the present invention through an entry point located on the top of the machine. This embodiment employs a dual layer of augers, which move the waste material to its end and onward to the next auger, which flows in the opposite direction. Upon reaching the end of the first layer, the material is fed into the second layer and, eventually, outward to be collected. The arrangement of the augers allows the material to be heated to higher temperatures more efficiently than with current techniques.

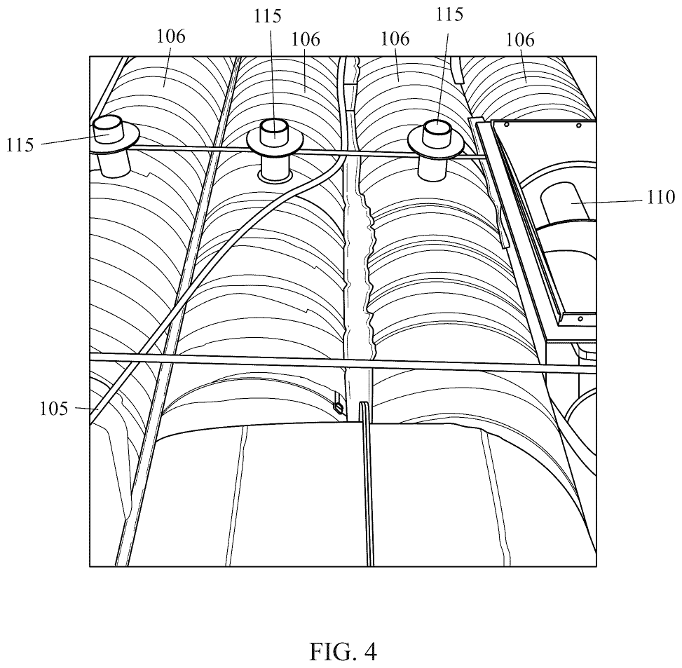

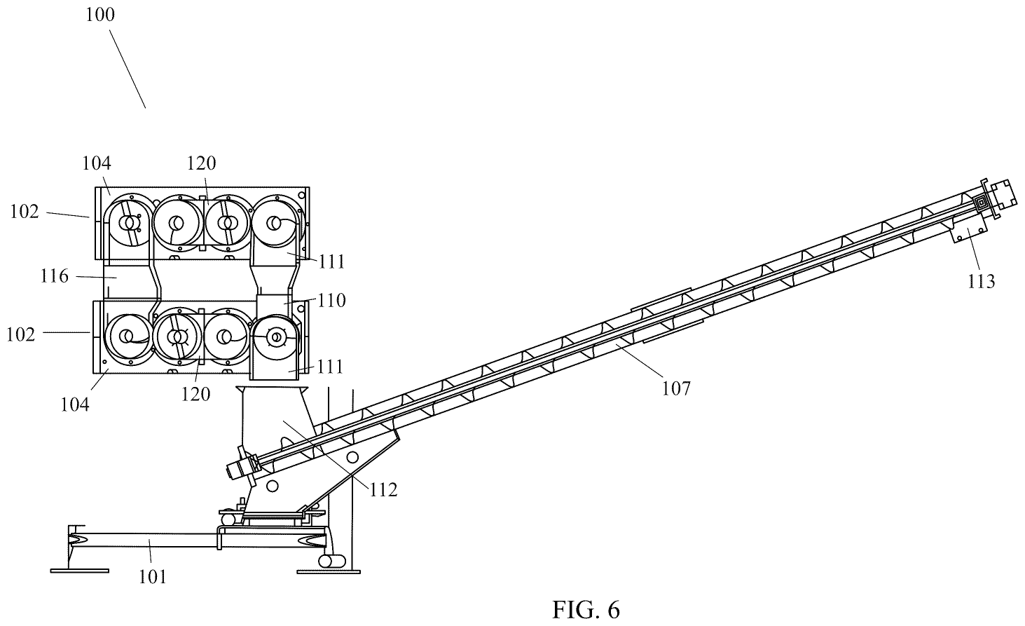

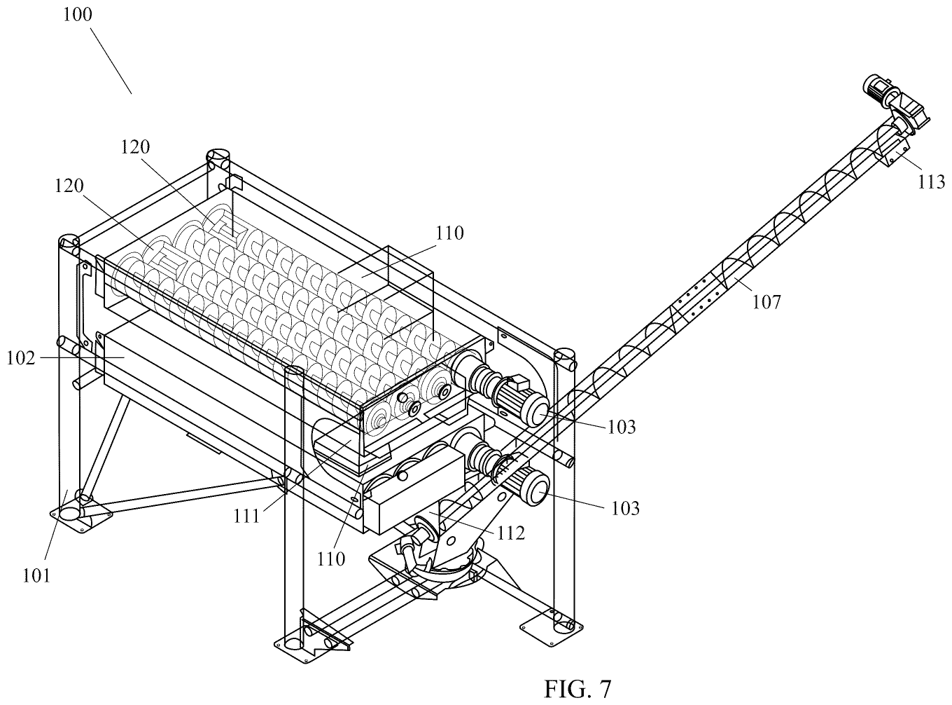

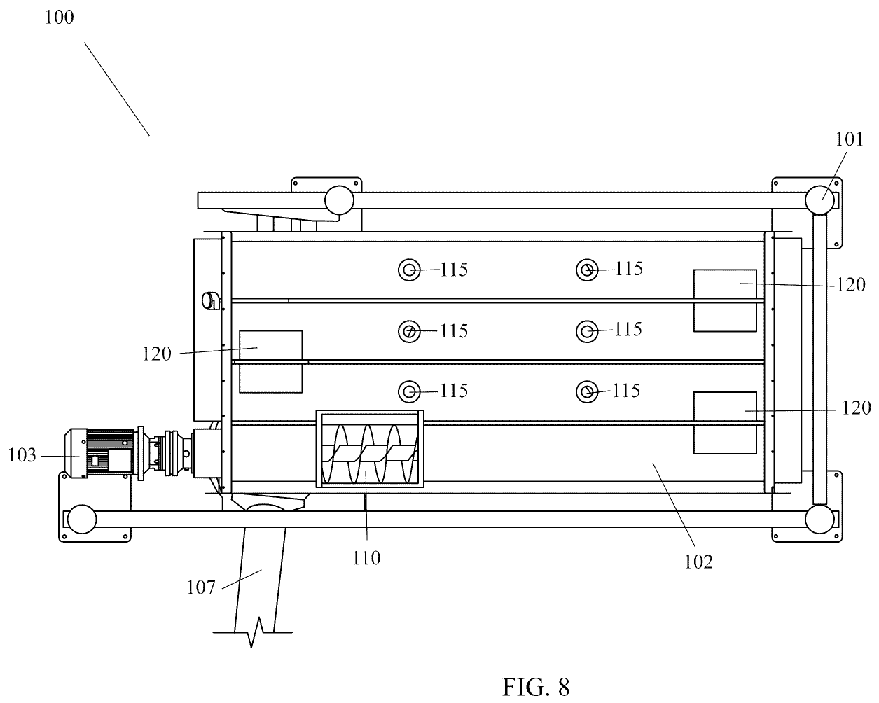

The present invention (100) comprises a supporting structure (101), a plurality of augers arranged in one or more layers (102), one or more motors (103), heating elements (105), insulation elements (106), and a deposit auger (107). The layers of augers (102) will typically comprise four or more augers arranged in parallel, where their rotation produces movement in the opposite direction of each adjacent auger in the layer. The example embodiment utilizes two layers of four augers, as depicted in FIGS. 4 and 6-8. Additional embodiments may utilize additional layers, with two or three layers being preferred. The material is fed into the machine (100) at the ingress chute (110) of the first auger layer (102). The augers within a layer (102) are connected such that once material is pushed through each individual auger, it will flow to be pushed through to the next successive auger via transfer region (120). The last auger in each layer is configured to push the material to the next position, through an egress chute (111), to either the ingress chute (110) of the next layer or to another designated position, typically an ingress chute (112) of the deposit auger (107). The deposit auger (107) in the example embodiment is configured to receive the finalized material and move it to a container through its own egress chute (113). Other embodiments may forego the deposit auger and have a receptacle or container positioned to receive the finalized material directly from the final egress chute (111) of the last auger layer (102).

Each individual auger within an auger layer (102) is wrapped in a combination of heating (105) and insulation (106) elements covering the enclosed portions of the auger. The example embodiment, see FIG. 4, depicts a wire-based heating element (105) with an external portion of the heating element (105) depicted while the bulk is bundled within the insulation elements (106). Alternate embodiments allow for the heating element (105) to comprise heating rods in lieu of wired elements, as well as other means to heat the internal chambers of the augers that would be understood by persons of ordinary skill in the art. Testing has shown that heating rods have superior performance to the use of wire-based heating elements. The heating elements are each connected to some power source, which may be incorporated into the machine or external. Some embodiments further incorporate one or more sensors to monitor and manage the temperature within the auger chamber(s). Typically, heating elements (105) will be interspersed within the insulation material (106) which is, in turn, contained within the casing (104) of each auger layer (102). Operation of the present invention is generally prepared by engaging the heating elements (105) and upon determining that the auger chambers have reached a sufficient initial temperature, material can then begin being introduced to the machine (100).

Each auger within a layer (102) as well as any present deposit auger (107) is connected to a motor (103) to affect the rotation of the auger(s). This connection may be by a motor directly turning an auger's shaft or through gears, pulleys, and other means of transferring rotational energy to the auger. Embodiments of the invention may have individual motors driving each auger, a single motor (103) per layer or drive direction, or a single motor (103) configured to drive each auger simultaneously. The example embodiment utilizes a single motor (103) for each auger layer (102) and another for the deposit auger (107). The motors (103) are each connected to some power source, which may be incorporated into the machine or external. Generally, the first layer (102) operates at the slowest rate with each subsequent auger layer (102) operating at a higher rate. This allows for the invention to avoid some concerns around material backup. However, the second and subsequent layers (102) may be operated at similar rates and retain some of the benefits, as desired by an operator.

Some embodiments may allow for a separate power source to provide energy for each of the powered components, particularly the motors (103) and heating elements (105), though the preferred embodiment would utilize a single power source for all components. Some embodiments will further incorporate safety mechanisms which allow for detection of material blockage, malfunctioning components, or other issues which would cause the machine to function improperly. These mechanisms would allow the machine to fail safe (stop function) and be in a state for manual troubleshooting. Such embodiments would necessarily utilize any present sensors and/or incorporate additional sensors to determine and identify one or more issues with the apparatus' function. Embodiments, including the example embodiment, may also incorporate gas vents (115) along the augers within the auger layer (102). These vents allow for byproduct gases to be captured or released. It is known that the Ammonia gas byproduct typical in manure processing can aid in disinfecting the system of microbial contaminants, so venting is optional.

The support structure (101) is configured to allow for the auger layers (102) to be held in a stable position relative to each other while the device (100) is generally freestanding. Some embodiments, including the example embodiment, incorporate a structural buffer (116) that helps the structure (101) provide stability to a rack configuration. Some embodiments may allow for the structure to be incorporated as a fixture in a greater structure, such as a building. Some embodiments also provide for scaffolding or other similar structural elements to enable operators to access higher areas about the machine (100).

Although the invention has been explained in relation to its preferred embodiment, it is to be understood that many other possible modifications and variations can be made without departing from the spirit and scope of the invention.

1. An apparatus for processing manure and similar materials, the device comprising:
a supporting structure;
one or more auger layers each comprising:
an ingress chute;
two or more augers arranged in parallel along a plane in a directional series;
one or more motors;
one or more heating elements;
one or more insulative elements; and
an egress chute;
wherein
the ingress chute is shaped and positioned to funnel material into a first of the two or more augers within the layer;
the chamber of the first auger is positioned to receive material through the ingress chute;
each auger is positioned to move material through its chamber length-wise by a screwing motion;
each auger is positioned to move material in the opposite length-wise direction of each adjacent auger in the layer;
the material exits each non-final auger chamber being deposited into a subsequent auger's chamber;
the material exits the final auger in the series' chamber through the egress chute;
the one or more heating elements and one or more insulative elements are arranged to form an envelope of each auger along its surfaces that do not receive or deposit material;
the one or more heating elements provide heat to the chambers during operation of the device; and
the one or more motors are arranged to power the turning of the augers;
wherein
the supporting structure is arranged such that each auger layer is positioned in parallel to any other auger layers; and
the one or more auger layers are arranged such that each subsequent auger layer after the first is positioned to receive material through its ingress chute from the prior auger layer's egress chute.

2. The apparatus of claim 1, further wherein one or more of the augers in each auger layer further comprises a gas vent.

3. The apparatus of claim 2, wherein one or more of the gas vents are attached to a gas sequestration device.

4. The apparatus of claim 1, wherein a movable container is positioned to receive the material moved through the final auger layer.

5. The apparatus of claim 1, further comprising a deposit auger which itself comprises:
an auger chamber;
an ingress chute positioned at the proximal end of the auger chamber;
an egress chute positioned at the distal end of the auger chamber; and
a motor;
wherein
the ingress chute is positioned to receive material through the final auger layer's egress chute;
the auger chamber is arranged to receive material from the ingress chute and move the material through along its length in a screwing fashion to the egress chute;
the motor is arranged to rotate the auger in its screwing motion; and
the material exits through the egress chute.

6. The apparatus of claim 1, wherein the supporting structure is incorporated into a building as a fixture.

7. The apparatus of claim 1, wherein the supporting structure comprises stairs and access walkways to one or more auger layers.

8. The apparatus of claim 1, wherein the one or more heating elements are heating rods.

9. The apparatus of claim 1, wherein the one or more heating elements are heating wires.

10. The apparatus of claim 1, wherein the one or more heating elements further comprise one or more sensors wherein those sensors are positioned along the one or more augers and electronically coupled with a device that provides temperature data pertaining to the environment within the chambers of the one or more augers.
